(19) United States
(12) Patent Application Publication
(10) Pub. No.: US 2023/0145209 A1
(43) Pub. Date: May 11, 2023

(54) SYSTEM AND METHOD FOR GROUP RESERVATIONS AND EVENT PLANNING

(71) Applicants: Michael Olivas, San Juan, PR (US); Jeffrey York, Riverview, FL (US)

(72) Inventors: Michael Olivas, San Juan, PR (US); Jeffrey York, Riverview, FL (US)

(21) Appl. No.: 17/981,093

(22) Filed: Nov. 4, 2022

Related U.S. Application Data
(60) Provisional application No. 63/276,857, filed on Nov. 8, 2021.

(51) Int. Cl. G06Q 10/02; G06Q 20/10; G06Q 30/04

(52) U.S. Cl. CPC G06Q 10/025; G06Q 20/102; G06Q 30/04

(57) ABSTRACT

A system for permitting a group administrator to book a group event is disclosed, including at least one user computing device in operable connection with a user network. An application server is in operable communication with the user network to host an application system for providing a system for booking a group event. The application system includes a user interface module for providing access to the application system through the user computing device or administrator computing device. The user interface module is in operable communication with a booking database storing one or more events, event aspects, and event prices to permit the user to select from the one or more events. A payment processing module permits the transmission of payment for the one or more events.

### REFERENCE TO PRIOR APPLICATION

This application claims priority of the provisional patent application 63/276,857, filed Nov. 8, 2021 entitled SYSTEM AND METHOD FOR GROUP RESERVATIONS AND EVENT PLANNING by Michael Olivas and Jeffrey York.

### FIELD OF THE INVENTION

The present invention relates to computerized systems for group reservations and event planning more specifically the present invention relates to group reservations and event planning.

### BACKGROUND

Group administrators are often tasked with booking various events and activities as well as reserving hotel rooms for each member of the group. Often, the group administrator will use an online reservation platform (e.g., “expedia.com” and “booking.com”) to reserve rooms for the group. These reservation platforms have limitations resulting in the inability to reserve more than nine rooms within the same booking. Instead, the administrator must manually submit a Request For Proposal (RFP) either through third-party RFP providers or directly to the hotel and/or event centers. The RFP often includes the requestor's information, event dates, rooms needed, as well as event-specific requests (e.g., meeting room requests, food, beverage requirements, accessibility requirements, etc.).

In the current arts, group administrators must submit RFPs to each hotel and/or event center they wish to book, often resulting in a complex negotiation process with multiple vendors. Further, these systems do not include means for receiving or managing financing for the group and subgroups thereof. The terms “computer system”, and “computer device” may be used interchangeably hereinafter. The reader should note not to confuse the profoundly distinct terms used herein. Specifically not to mix the terms “aspects of an event”. “event aspect” and alike as explained below, specifically in connection with the present invention, with other entirely different terms, commonly used in patent application writing such as, “aspects of the invention”, and “aspects of the disclosure”.

### SUMMARY OF THE INVENTION

This summary is provided to introduce a variety of concepts in a simplified form that are disclosed further in the detailed description of the embodiments. This summary is not intended to identify key or essential inventive concepts of the claimed subject matter, nor is it intended for determining the scope of the claimed subject matter.

A system according to the present invention permits a group administrator or other system users to collaboratively book a group event, including at least one user computing device in an operable connection with a user network. An application server is in operable communication with the user network to host an application system for providing system for booking a group event. The application system includes a user interface module for providing access to the application system through the user computing device or an administrator computing device. The user interface module is in operable communication with a booking database storing one or more events, event aspects, and event prices to permit the user to select from one or more events. A payment processing module permits the transmission of payment for one or more events.

A group administrator can utilize a system embodying the present invention to book an event and event aspects thereof for a group of individuals. The event aspects may include hotels, activities, food and beverage packages, travel accommodations, and the similar event aspects which are often required when planning for a group of individuals. The system can be used for various group events such as parties, group travel, fraternity/sorority events, weddings, spring break travel, bachelor/bachelorette parties, family reunions, etc. As a system user, the group administrator can utilize a user interface to browse events and event aspects thereof and they are able to view pre-negotiated prices for each event aspect they wish to book. The event prices and packages are pre-negotiated to remove the need for the group administrator to contact the hotel, activity managers, food and beverage purveyors, etc. to organize, plan, and execute contracts for the event.

According to some embodiments the group administrator can view static pricing for the various aspects of the event. The pre-negotiated prices may be adjusted based on the chosen accommodations, number of individuals attending the event, location, time of year, etc. The pre-negotiation may include negotiating a deposit amount, such as requiring a deposit (i.e., the payment threshold) for the event to be booked. In this case, the group administrator collects and submits the threshold payment before the booking is confirmed and the event is reserved.

In some embodiments, a room assignment engine allows each member of the group to select room options including whether they want to have their own hotel room, if they want to room with a specific other group member or select the number of people in their room. In some examples embodying the present invention the room assignment engine may then preclude future selection from users, such as not double-booking a group member in two separate rooms.

In some cases exemplifying the present invention, the system allows for payments to be split by members of the group. For example, couples may pay for their portion of the fees as a group, rather than splitting the payments equally between all individuals in the group. Similarly, the system may facilitate the booking of rooms based on subgroups (e.g., couples) to ensure couples are given their own room if desired.

A system according to some embodiments provides one or more goal gauges to allow users to easily view payments already submitted, payment thresholds (e.g., down payment amount, goals, etc.) and total payment amount required. The system may provide a goal gauge for attendees (i.e., a gauge representing the number of attendees who have provided an RSVP, attendees who have paid, etc.).

A system according to some embodiments allows the user to select from one or more hotels and one or more venues in suitable proximity. Suitable proximity can be pre-defined in a variety of ways, such as by walking distance, driving distance, as the crow flies, within the boundaries of a certain district. Once the user has selected the hotel, venue, and any add-ons or extra packages, the system will generate a quote that can be saved in the database. The user can then compare quotes and packages and make the reservation, himself or by the group administrator, in the hotel and/or venue according to their decision. The pricing for events are pre-negotiated and may be displayed to users/group administrators such that they can compare hotels, venues, add-ons, and packages without contacting each party individually.

A system according to some embodiments enables the group administrator to optionally publish the quoted packages to all or specific individual users during the pre-negotiation phase, gather feedback, and allows users to vote on the desired package.

A system according to some embodiments allows the group administrator to accept the desired quote and electronically sign a planning agreement. RFPs are automatically generated and submitted to the group travel department contacts at hotels and venues. The group travel departments may either accept (unconditionally or conditionally) or reject the RFP. Upon acceptance, the system books the event including the activities of generating contracts, facilitating final review/negotiation, collecting electronic signatures.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates schematically a block diagram of a computing system, according to some embodiments of the present invention;

FIG. 2 illustrates schematically a block diagram of a computing system and an application program, according to some embodiments of the present invention.

FIG. 3 illustrates schematically a block diagram of the application program, according to some embodiments of the present invention; and

FIG. 4 illustrates schematically a flowchart of a method for booking a group event, according to some embodiments of the present invention.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In various embodiments, a computer implemented method and system configured to execute instructions for performing the method are provided. As shown in the figures, the embodiments in this disclosure generally relate to a system, method, and/or computer program product which allow a group administrator to book various event aspects of an event including, hotel rooms, event venues, food and beverage packages, meeting rooms, and other event aspects which are often reserved in advance of an event. The embodiments allow for group payments and financing to be received from the group administrator while allowing the group administrator to collect payment from each member of the group.

In general, the embodiments described herein relate to a system, method, and/or computer program product that allows for a group administrator to book an event and event aspects thereof for a group of individuals. The event aspects may include hotels, activities, food and beverage packages, travel accommodations, and the like which are often required when planning for a group of individuals. The system can be used for various group events such as parties, group travel, fraternity/sorority events, weddings, spring break travel, bachelor/bachelorette parties, family reunions, etc. The group administrator utilizes a user interface to browse events and event aspects thereof. The event prices and packages are pre-negotiated to remove the need for the group administrator to contact the hotel, activity managers, food and beverage purveyors, etc. to organize and plan the event.

According to some embodiments of the invention a group administrator can view static pricing for the various aspects of the event. The prices are pre-negotiated to save the group administrator time by removing the need to contact various third parties for availability and negotiate a fair price. The pre-negotiated prices may be negotiated based on the accommodations, the number of individuals attending the event, etc. The pre-negotiation may include negotiating a deposit amount, such as requiring a deposit (i.e., the payment threshold) in order for the event to be booked.

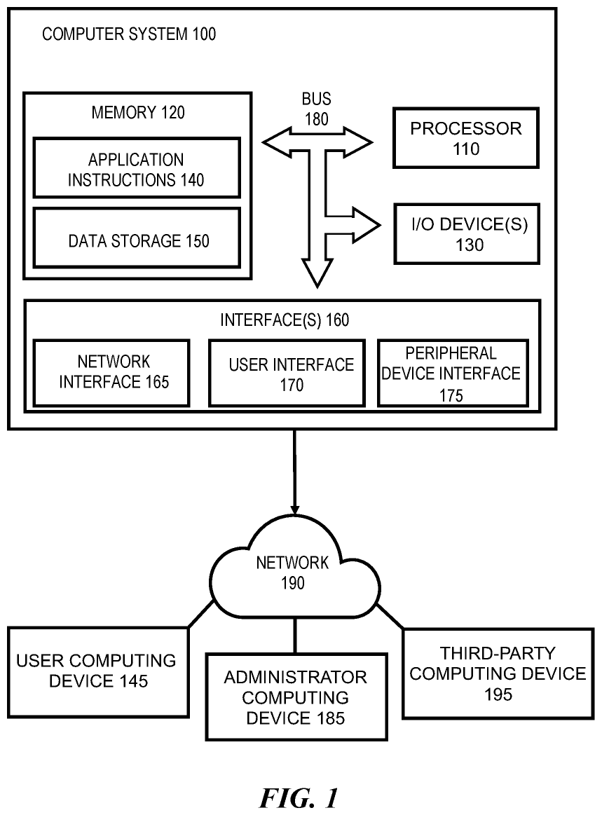

FIG. 1 illustrates an example of computer system 100 that may be utilized to execute various procedures, including the processes described herein. Computer system 100 may include one or more of a standalone computer or mobile computing device, a mainframe computer system, a workstation, a network computer, a desktop computer, a laptop, or the like. Computing device 100 can be embedded in another device. e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus. Micro Channel Architecture (MCA) bus. Enhanced ISA (EISA) bus, Video Electronics Standards Association (VESA) local bus, and Peripheral Component Interconnect (PCI) bus, also known as Mezzanine bus.

In some embodiments, computer system 100 includes one or more input/output (I/O) devices 130, such as video device(s) (e.g., a camera), audio device(s), and display(s) are in operable communication with computer system 100. In some embodiments, similar I/O devices 130 may be separate from computer system 100 and may interact with one or more nodes of computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or several processing units and may include single or multiple computing units or multiple processing cores. Processor(s) 110 can be implemented as one or more microprocessors, microcomputers, microcontrollers, digital signal processors, central processing units, state machines, logic circuitries, and/or any devices that manipulate signals based on operational instructions. For example, processor(s) 110 may be one or more hardware processors and/or logic circuits of any suitable type specifically programmed or configured to execute the algorithms and processes described herein. Processor(s) 110 can be configured to fetch and execute computer-readable program instructions stored in the computer-readable media, which can program processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum dot-based transistors, switches, and gates, to optimize space usage or enhance the performance of user equipment. A processor can also be implemented as a combination of computing processing units.

In some embodiments, memory 120 includes computer-readable application instructions 150, configured to implement certain embodiments described herein, and database 150, comprising various data accessible by application instructions 140. In some embodiments, application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, the terms “store.” “storage,” “data store.” data storage,” “database,” and substantially any other information storage component relevant to the operation and functionality of a component are utilized to refer to “memory components.” which are entities embodied in a “memory.” or components comprising a memory. Those skilled in the art would appreciate that the memory and/or memory components described herein can be volatile memory, nonvolatile memory, or both volatile and nonvolatile memory. Nonvolatile memory can include, for example, read-only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer-readable storage medium (or media) can be a tangible device that can retain and store instructions for use by an instruction execution device. The computer-readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer-readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer-readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of application instructions 140 described herein are embodied directly in hardware, in a software module executed by a processor, or in a combination of the two. A software module may reside in RAM, flash memory, ROM memory, EPROM memory. EEPROM memory, registers, a hard disk, a removable disk, a CD-ROM, or any other form of storage medium known in the art. An exemplary storage medium may be coupled to processor 110 such that processor 110 can read information from, and write information to, the storage medium. In the alternative, the storage medium may be integrated into processor 110. Further, in some embodiments, processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, application instructions 140 for carrying out operations of the present disclosure can be assembler instructions, instruction-set-architecture (ISA) instructions, machine instructions, machine-dependent instructions, microcode, firmware instructions, state setting data, configuration data for integrated circuitry, or either source code or object code written in any combination of one or more programming languages, including an object-oriented programming language such as Smalltalk. C++, or the like, and procedural programming languages, such as the “C” programming language or similar programming languages. Application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field programmable gate arrays (FPGA), or programmable logic arrays (PLA) can execute the computer-readable program instructions by utilizing state information of the computer-readable program instructions to personalize the electronic circuitry, in order to perform aspects of the present disclosure.

In some embodiments, application instructions 140 can be downloaded to a computing/processing device from a computer-readable storage medium, or to an external computer or external storage device via network 190. A network adapter card or network interface in each computing/processing device receives computer-readable program instructions from the network and forwards the computer-readable application instructions 140 for storage in a computer-readable storage medium within the respective computing/processing device.

In some embodiments, computer system 100 includes one or more interfaces 160 that allow computer system 100 to interact with other systems, devices, or computing environments. In some embodiments, computer system 100 comprises network interface 165 to communicate with network 190. In some embodiments, network interface 165 is configured to allow data to be exchanged between computer system 100 and other devices attached to network 191), such as other computer systems, or between nodes of computer system 100. In various embodiments, network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include user interface 170 and peripheral device interface 175.

In some embodiments, network 190 corresponds to a local area network (LAN), wide area network (WAN), the Internet, a direct peer-to-peer network (e.g., device-to-device Wi-Fi, Bluetooth, etc.), and/or an indirect peer-to-peer network (e.g., devices communicating through a server, router, or other network devices). Network 190 can comprise copper transmission cables, optical transmission fibers, wireless transmission, routers, firewalls, switches, gateway computers, and/or edge servers. Network 190 can represent a single network or multiple networks. In some embodiments, network 190 used by the various devices of computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/iP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of the medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid-state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, CSS, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”). Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, shown in FIG. 1 computer system 100 may include user computing device 145, administrator computing device 185, and third-party computing device 195 each in communication via network 190. User computing device 145 may be utilized by users including users who are a part of a group attending an event. Administrator computing device 185 is utilized by the group administrator who is tasked with booking the event for a group of users. Third-party computing device 195 may be utilized by third-parties including managers of an event location, hotel managers, activity managers, and the like.

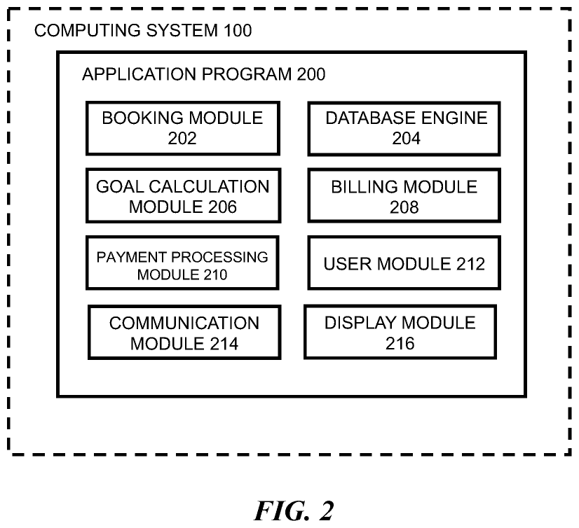

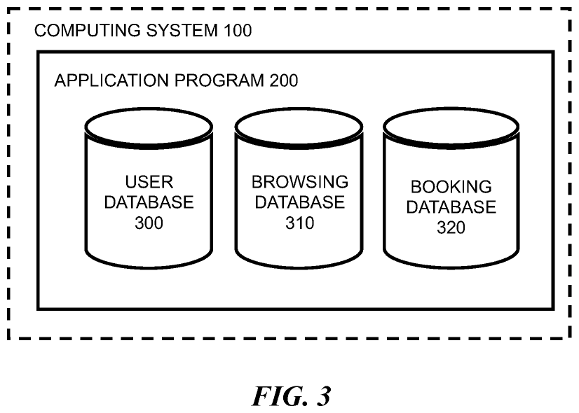

FIGS. 2 and 3 illustrate an example of computer architecture for application program 200 operated via computing system 100. Computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within application program 200, and FIG. 3 is a block diagram showing the various databases utilized by the various modules.

Referring to FIG. 2, computing system 100 operating application program 200 comprises one or more modules having the necessary routines and data structures for performing specific tasks, and one or more engines configured to determine how the platform manages and manipulates data. In some embodiments, application program 200 includes one or more o-f a booking module 202, a database engine 204, a goal calculation module 206, a billing module 208, a payment processing module 210, a user module 212, a communication module 214, and a display module 216.

In some embodiments, booking module 202 permits the user to view booking options and select to book various events, reservations, and associated event aspects thereof. For example, booking module 202 permits the user to select and to book ten hotel rooms for a group at a pre-determined rate. The pre-determined rate is negotiated by the service provider, or system operator, or system administrator or other individuals with the hotel personnel. In such, the group administrator does not need to negotiate the hotel to attempt to negotiate the best rate.

In some embodiments, database engine 204 is configured to facilitate the storage, management, and retrieval of data to and from one or more storage mediums, such as the one or more internal databases described herein. In some embodiments, database engine 204 is coupled to an external storage system. In some embodiments, database engine 204 is configured to apply changes to one or more databases. In some embodiments, the database engine 204 comprises a search engine component for searching through thousands of data sources stored in different locations. In such, database engine 204 allows the user to search various hotels, events, food and beverage packages, travel accommodations, etc.

In some embodiments, goal calculation module 206 allows the user to establish and input a goal for a group event. The goal may include a budget, hotel room specifications, food and beverage specifications, preferred travel accommodations and scheduling, preferred activities, and the like. For example, the user may select to book a skiing trip for thirty individuals along with twenty hotel rooms split between predetermined subgroups of the individuals. Further, the user may input a budget for the entire trip.

In some embodiments, goal calculation module 206 facilitates the establishment of payment goals to aid in the budgeting of an event for a predetermined period of time prior to the event. For example, if event trip is scheduled six-months in the future, the goal calculation module 206 permits the user to establish payment deadlines throughout the six-month time period (e.g., partial payments on the first day of each month).

In some embodiments, billing module 208 schedules billing via the transmission of invoices between the system application program 200 and the group administrator and/or users of the application program 200. Further, billing module 208 may permit the group administrator to transmit bills to the individuals (i.e., the users) attending the event. Billing module 208 may be in operable communication with goal calculation module 206 to transmit an invoice to each individual at predetermined time periods.

In some embodiments, the payment processing module 210 may be operable to receive payments from the group administrator or other users of the system to pay for an event which is booked. The payment processing module 210 may permit financing of the entire and/or partial amounts of the cost of the booked event.

In some embodiments, the user module 212 facilitates the creation of a user account for the application system. In such, the user account may be associated with a group administrator, individual user, etc. to allow the user to establish user preferences, book events and event aspects thereof, and otherwise interact with the system functionalities described herein.

In some embodiments, communication module 214 is configured for receiving, processing, and transmitting a user command and/or one or more data streams. In such embodiments, communication module 214 performs communication functions between various devices, including user computing device 145, administrator computing device 185, and a third-party computing device 195. In some embodiments, the communication module 214 is configured to allow one or more users of the system, including a third-party, to communicate with one another. In some embodiments, the communications module 214 is configured to maintain one or more communication sessions with one or more servers, the administrator computing device 185, and/or one or more third-party computing device(s) 195.

In some embodiments, display module 216 is configured to display one or more graphic user interfaces, including, e.g., one or more user interfaces, one or more consumer interfaces, one or more video presenter interfaces, etc. In some embodiments, display module 216 is configured to temporarily generate and display various pieces of information in response to one or more commands or operations. The various pieces of information or data generated and displayed may be transiently generated and displayed, and the displayed content in display module 216 may be refreshed and replaced with different content upon the receipt of different commands or operations in some embodiments. In such embodiments, the various pieces of information generated and displayed in display module 216 may not be persistently stored.

As shown in FIG. 3, a plurality of databases is included with application program 200 and each database is in communication with the various components in the application program 200 via database engine 204. In some embodiments, for example, the platform comprises user database 300, browsing database 310, and booking database 320.

In some embodiments, user database 300 contains stored data related to the users that use application program 200. In such embodiments, user database 300 stores usernames, login information, and user profile information, as well as any other information supplied by a user, such as financial or banking account information and payment methods. User database 300 may also store user preferences such as budget thresholds, or the user's interests to aid the system in suggesting specific events. In some embodiments, user database 300 stores previously booked events for each user.

In some embodiments, browsing database 310 contains stored data related to consumer engagement with an integrated booking engine. For example, browsing module 202 is configured to capture consumer activities on the integrated booking engine, such as location information, group information, activity preferences, etc. In some embodiments, browsing database 310 stores the captured user clicks for each user session. In some embodiments, browsing database 310 stores the captured user clicks over a predetermined period of time. In such embodiments, the stored data can be used to analyze how often certain event aspect pages were viewed.

In some embodiments, booking database 320 contains stored data related to event aspects. As used herein, event aspects may include pricing information, activities and prices thereof, food and beverage package information and prices thereof, travel accommodation information and prices thereof, as well as other selectable aspects of the event.

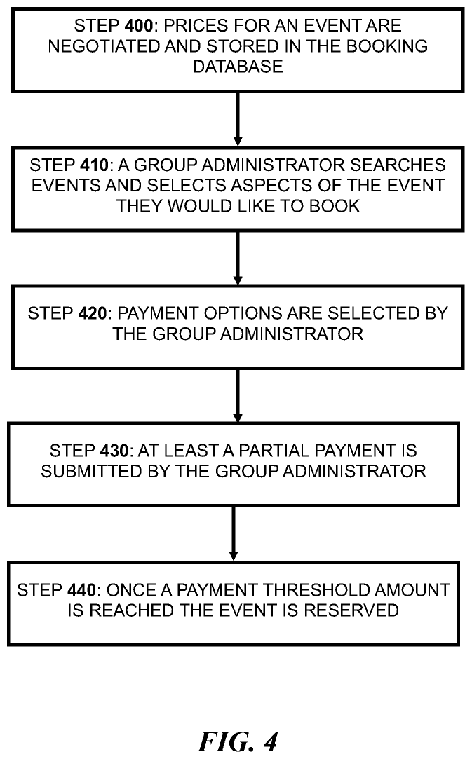

FIG. 4 illustrates a flowchart of a method for booking an event for a group of individuals, wherein the pricing for the event is pre-negotiated to provide a convenient and efficient means for organizing a group event. In step 400, prices for an event and event aspects thereof are negotiated. The negotiated prices are stored in the booking database to permit a group administrator, in step 410, to search events and select aspects of the event they would like to book. In step 420, payment options are selected by the group administrator. For example, the group administrator may select to pay for the event in full, or partially pay for the event. In step 430, the at least partial payment is submitted by the group administrator and/or individuals within the group. In step 440, the system determines if a threshold payment amount is reached in order for the event to be reserved and booked. For example, the system may require a deposit payment for the event to be booked.

In some embodiments, and during use, users can select an event theme, city. etc. such as selecting New Orleans as a destination city. Once the city is selected, the user can select a date or range of dates that the event will occur. When selecting the event, the user will be given an estimate of the price per couple or per predetermined number of people. Once the city and date are selected, the user can select the hotel using various parameters including location, price, group size, amenities, etc. Once a hotel is selected, the user may select a venue (e.g., a bar, restaurant, event center, etc.) which the user and their group will attend in addition to the hotel they have selected. The venues listed as selectable options correspond to the location of the selected hotel. The system may provide information such as proximity between the hotel and venue, venue details and amenities, scheduling information (i.e., itinerary), etc. Each venue will include an estimated price per couple such that the user can make an informed decision when selecting the hotel and venue for their group event. Once both the hotel and venue are selected, the system calculates a total price per couple (or other number of users). In some embodiments, users may select a hotel only or a venue only.

In some embodiments, the user may select various packages or options when selecting the venue. For example, the user may select to have gourmet appetizers, buffet, three course meals, or other add-on options. Similarly, the user may select to have no food provided. Selecting the add-on features may automatically adjust the pricing of the venue.

In some embodiments, the user may create a profile for the event. The profile may include selecting a university, fraternity, fraternity chapter, down payment amount, and other details.

In some embodiments, once the profile for the event is created, a quote is generated which is saved in the database. This allows the user to generate a one or more quotes and compare quotes between locations and/or venues as well as compare the difference between packages and add-ons selected at each location and venue.

In some embodiments, once the user (and their associated group) agrees on a quote, the system sends a message to the hotel and/or the venue asking for approval of the quote and details thereof. This allows the hotel and/or venue to review the group information and the quote generated by the user and accept or deny the quote. Once accepted, the user is prompted to pay a down payment or other deposit amount. A minimum payment amount may be established by the system administrator, hotel administrator, venue administrator, etc. to collect a profitable payment amount from the user for each event.

In some embodiments, once the event is accepted by the hotel and/or venue, the user is provided with a goal gauge which shows the amount of money which has been received from the group associated with the user, and/or the number of attendees which are attending, the event. This may be provided in two separate gauges. For example, if the group needs $10,000 to pay for the event and a down payment of $3,000 has been collected, the goal gauge would illustrate $3,000 having been paid of the total amount. This allows the user to track funding and monitor goals for receiving payment during the time leading up to the event. Payments may be made by the administrative user of the group or by individual members of the group throughout the funding process.

In some embodiments, the platform includes a room assignment engine. Each member of the group can select room options including whether they want to have their own hotel room, if they want to room with a specific other group member or select the number of people in their room. The room assignment engine may then preclude future selection from users, such as not double-booking a group member in two separate rooms.

For pre-negotiating prices the system operator or the service provider can retrieve past quotes stored in the system. e.g., in the booking database, and re-negotiate the prices with the hotels or venues to achieve better pre-negotiated prices for the users and/or group administrators. The system allows for pre-negotiated rates (prices) of hotels, venues, add-ons (e.g., food packages), packages. etc. to be automatically displayed to the user or group administrator when researching and scheduling an event. This allows the user to easily make a reservation for an event for both the hotel and venue. The system then receives payment(s) from the group administrator or other user(s) associated with the group. A threshold value may be preestablished for the event to ensure the event is profitable.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including a single processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system.” “platform.” “interface.” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that rum software programs. The AP generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

1. A system for permitting a group administrator to book a group event, the system comprising:
at least one user computing device in operable communication with a user network;
an application server in operable communication with the user network, the application server configured to host an application system for booking a group event, the application system having a user interface module for providing access to the application system through the user computing device or a group administrator computing device, the user interface module in operable communication with a booking database storing one or more events, event aspects, and pre-negotiated event prices, the user interface module permits the user or group administrator to select from the one or more events; and
a payment processing module to permit the transmission of payment for the one or more events.

2. The system of claim 1, comprising a database engine allowing the user or the group administrator to search various packages.

3. The system of claim 1, wherein the user interface module allows the user or the group administrator to select from one or more hotels and from one or more venues in suitable proximity.

4. The system of claim 1, comprising room assignment engine for allowing group members to select other group members in their room.

5. The system of claim 1, wherein the processing module permits financing at least partial amounts of the cost of the booked event.

6. The system of claim 5 permitting group payments and financing to be received from the group administrator while allowing the group administrator to collect payment from members of the group.

7. The system of claim 1, further comprising a goal calculation module to permit a group administrator to establish one or more goals, wherein the one or more goals include a budget.

8. The system of claim 1, further comprising a billing module for transmitting one or more invoices and payment processing module allowing receiving one or more payments from the group administrator.

9. A method for booking a group event, the method comprising the steps of:
providing a user or a group administrator access to an application system;
storing in a booking database, one or more events, one or more event aspects, and one or more pre-negotiated event prices;
permitting the user or the group administrator to search using a database engine and select from the one or more events using a user interface module:
permitting transmission of at least a partial payment for the one or more events using a payment processing module; and
permitting reservation of the one or more events using a booking module.

10. The method of claim 9 comprising permitting the user or the group administrator to select one or more payment options.

11. The method of claim 9 comprising verifying if a payment threshold was received for allowing reservation of the event.

12. The method of claim 9, wherein the reservation of the event is subject to the transmission of a pre-negotiated payment threshold of a deposit amount.

13. The method of claim 9, further comprising the step of establishing one or more goals using goal calculation module, wherein the one or more goals related to an event selected from the group consisting of budget hotel room specifications, food and beverage specifications, travel accommodations, scheduling, preferred activities and combinations thereof.

14. The method of claim 9, wherein the group administrator is permitted to reserve more than nine hotel rooms in one booking period.

15. The method of claim 9, comprising permitting group payments and financing to be received from the group administrator while allowing the group administrator to collect payment from members of the group.
